(19) United States
(12) Patent Application Publication
(10) Pub. No.: US 2014/0355809 A1
(43) Pub. Date: Dec. 4, 2014

(54) FLEXIBLE EARTIP WITH RETENTION BASE

(71) Applicant: Etymotic Research, Inc., Elk Grove Village, IL (US)

(72) Inventors: Mead C. Killion, Elk Grove Village, IL (US); Viorel Drambarean, Lincolnwood, IL (US)

(73) Assignee: Etymotic Research, Inc., Elk Grove Village, IL (US)

(21) Appl. No.: 14/287,502

(22) Filed: May 27, 2014

Related U.S. Application Data
(60) Provisional application No. 61/827,843, filed on May 28, 2013.

(51) Int. Cl. H04R 1/10

(52) U.S. Cl. CPC H04R 1/1058; H04R 1/1016
USPC 381/380

(57) ABSTRACT

Certain embodiments provide an eartip. The eartip includes a flexible body, a sound channel, and a retention base. The flexible body is bendable at curves of an ear canal of a wearer. The sound channel is disposed within the flexible body. The sound channel includes a first end inlet and a second end outlet. The sound channel is generally parallel with the flexible body. The retention base includes a retention base inlet, one or more retention cavities, and at least one protrusion. The one or more retention cavities extend from the retention base inlet to the first end inlet of the sound channel. The one or more retention cavities are configured to receive a hearing device. The at least one protrusion is configured to detachably secure the hearing device within the one or more retention cavities.

### CROSS-REFERENCE TO RELATED APPLICATIONS/INCORPORATION BY REFERENCE

The present application claims priority under 35 U.S.C. §119(e) to provisional application Ser. No. 61/827,843, filed on May 28, 2013. The above referenced provisional application is hereby incorporated herein by reference in its entirety

U.S. Pat. No. 4,677,679 issued to Killion on Jun. 30, 1987, is incorporated by reference herein in its entirety.

U.S. Pat. No. 4,763,753 issued to Killion on Aug. 16, 1988, is incorporated by reference herein in its entirety.

U.S. Pat. No. 5,113,967 issued to Killion et al. on May 19, 1992, is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to eartips for sealing within an ear canal and coupling with hearing devices, such as earphones or plugs. More specifically, the present invention relates to a flexible eartip that includes a retention base operable to receive and secure a hearing device in at least one retention cavity adjacent to a sound channel of the eartip. In various embodiments, the sound channel of the eartip includes a damper at a predetermined distance from an outlet of the sound channel.

Existing eartips typically include a body for sealing within an ear canal and a sound channel extending through the body. The eartips typically couple to an earphone or plug by stretching the body around a sound tube of an earphone or a stem of a plug such that the sound tube or stem extends into the sound channel. Some existing earphone sound tubes and/or earplug stems include a damper or filter for modifying the frequency response of sound transmitted into a wearer's ear canal. Sound tubes or stems that extend into a sound channel of an eartip can limit the flexibility of the eartip, which can be uncomfortable to a wearer.

FIG. 1A depicts a side view of an eartip as is known in the art. FIG. 1B depicts a perspective view of an eartip as is known in the art. FIG. 1C depicts a cross-sectional view of an eartip as is known in the art. FIG. 1D depicts a partial cross-sectional view of an eartip coupled to an earphone as is known in the art. Referring to FIGS. 1A-1D, an exemplary existing flexible eartip 100 can include a body 110 with a sound channel 120 extending through the body 110. The body 110 can include, or be attached to, flanges 115, compressible foam, or the like. The sound channel 120 may include a first end inlet 121 operable to receive a sound tube 15 of an earphone 10, and a second end outlet 122 operable to transmit sound from the sound channel 120 into an ear canal of a wearer. As illustrated in FIG. 1D, a sound tube 15 of an earphone 10, which may include a damper or filter (not shown), is coupled to the eartip 100 by stretching the body around the sound tube 15 of the earphone 10 such that the sound tube 15 extends into the sound channel 120. The sound tube 15 may limit the flexibility of the eartip 100, which may provide an uncomfortable fit for a wearer and/or prevent the eartip 100 from creating a seal in an ear canal of a wearer.

Further limitations and disadvantages of conventional and traditional approaches will become apparent to one of skill in the art, through comparison of such systems with some aspects of the present invention as set forth in the remainder of the present application.

### SUMMARY OF THE INVENTION

Certain embodiments of the present technology provide flexible eartips with retention bases, substantially as shown in and/or described in connection with at least one of the figures.

These and other advantages, aspects and novel features of the present invention, as well as details of an illustrated embodiment thereof, will be more fully understood from the following description and drawings.

### BRIEF DESCRIPTION OF THE DRAWING(S)

FIG. 1A depicts a side view of an eartip as is known in the art.

FIG. 1B depicts a perspective view of an eartip as is known in the art.

FIG. 1C depicts a cross-sectional view of an eartip as is known in the art.

FIG. 1D depicts a partial cross-sectional view of an eartip coupled to an earphone as is known in the art.

FIG. 2A depicts a side view of an exemplary flexible eartip with retention base in accordance with embodiments of the present technology.

FIG. 2B depicts a perspective view of an exemplary flexible eartip with retention base in accordance with embodiments of the present technology.

FIG. 2C depicts a cross-sectional view of an exemplary flexible eartip with retention base in accordance with embodiments of the present technology.

FIG. 2D depicts a partial cross-sectional view of an exemplary flexible eartip with retention base coupled to an earphone in accordance with embodiments of the present technology.

FIG. 3A depicts a side view of an exemplary extension base attached to a flexible eartip in accordance with embodiments of the present technology.

FIG. 3B depicts a perspective view of an exemplary extension base attached to a flexible eartip in accordance with embodiments of the present technology.

FIG. 3C depicts a cross-sectional view of an exemplary extension base attached to a flexible eartip in accordance with embodiments of the present technology.

FIG. 3D depicts a partial cross-sectional view of an exemplary extension base attached to a flexible eartip and coupled to an earphone in accordance with embodiments of the present technology.

FIG. 4 depicts a cross-sectional perspective view of an exemplary flexible eartip with retention base in accordance with embodiments of the present technology.

FIG. 5A depicts a cross-sectional view of an exemplary flexible eartip with retention base in accordance with embodiments of the present technology.

FIG. 5B depicts a partial cross-sectional view of an exemplary flexible eartip with retention base coupled to an earphone in accordance with embodiments of the present technology.

FIG. 6A depicts a side view of an exemplary flexible eartip with retention base in accordance with embodiments of the present technology.

FIG. 6B depicts a perspective view of an exemplary flexible eartip with retention base in accordance with embodiments of the present technology.

FIG. 6C depicts a cross-sectional view of an exemplary flexible eartip with retention base in accordance with embodiments of the present technology.

FIG. 6D depicts a partial cross-sectional view of an exemplary flexible eartip with retention base coupled to an earphone in accordance with embodiments of the present technology.

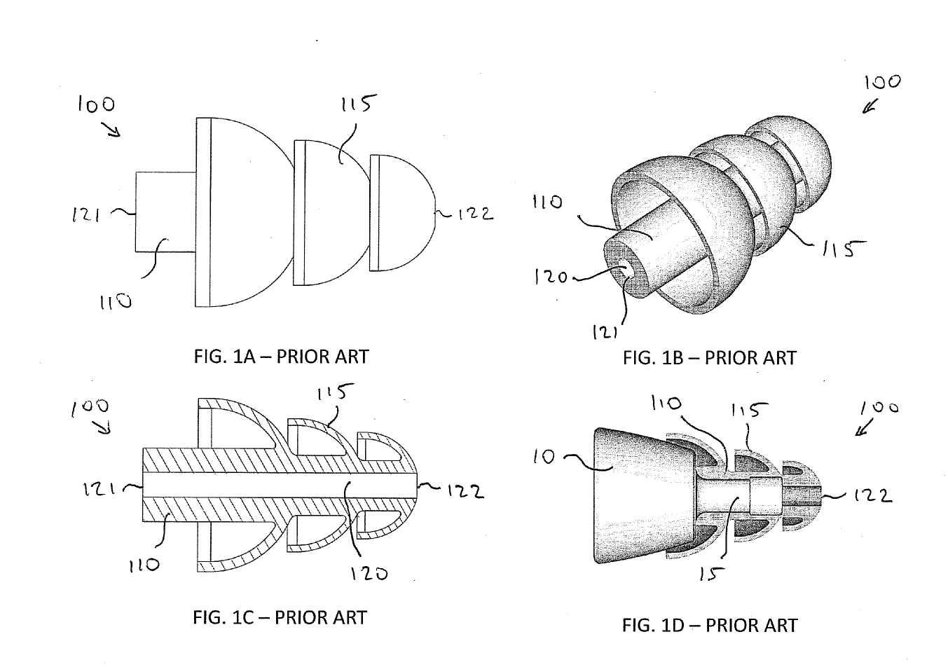

### DETAILED DESCRIPTION OF PREFERRED EMBODIMENT(S)

Embodiments of the present technology provide a flexible eartip that includes a retention base operable to receive and secure an earphone or plug in at least one retention cavity adjacent to a sound channel of the eartip. In various embodiments, the sound channel of the eartip includes a damper at a predetermined distance from an outlet of the sound channel.

Various embodiments provide an eartip 200, 300, 400 that may comprise a flexible body 210, 310, 410, 510, a sound channel 220, 320, 420, 520, and a retention base 211, 330, 411, 511. The sound channel 220, 320, 420, 520 can be disposed within the flexible body 210, 310, 410, 510. The sound channel 220, 320, 420, 520 may comprise a first end inlet 221, 321, 421, 521 and a second end outlet 222, 322, 422, 522. The retention base 211, 330, 411, 511 can comprise a retention base inlet 214, 335, 414, 514, one or more retention cavities 213, 334, 413A, 413B, 513A, 513B, and at least one protrusion 212, 333, 412A, 412B, 512A, 512B. The one or more retention cavities 213, 334, 413A, 413B, 513A, 513B may extend from the retention base inlet 214, 335, 414, 514 to the first end inlet 221, 321, 421, 521 of the sound channel 220, 320, 420, 520. The one or more retention cavities 213, 334, 413A, 413B, 513A, 513B may be configured to receive a hearing device 10. The at least one protrusion 212, 333, 412A, 412B, 512A, 512B may be configured to detachably secure the hearing device 10 within the one or more retention cavities 213, 334, 413A, 413B, 513A, 513B.

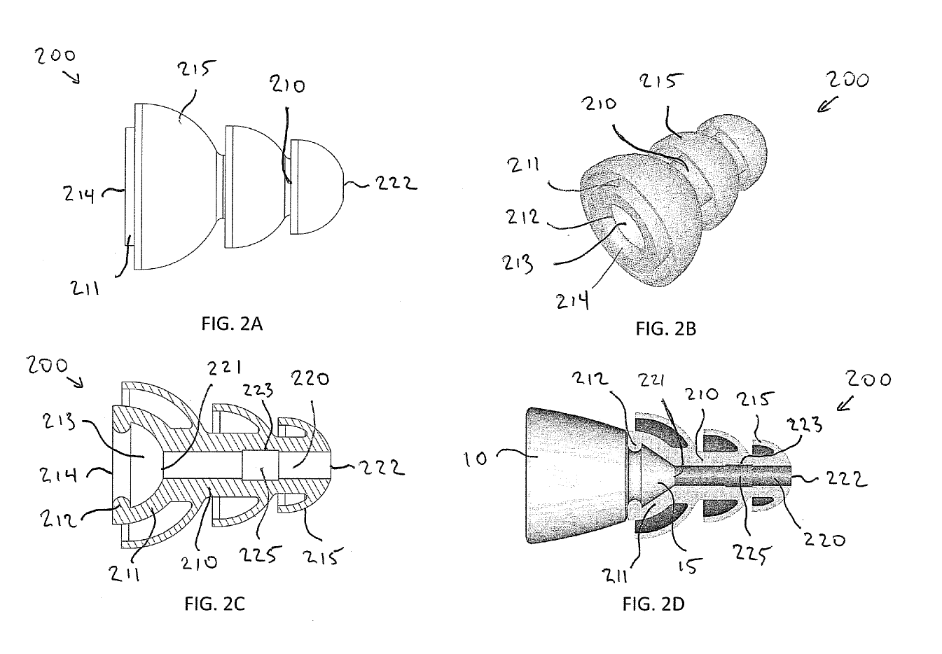

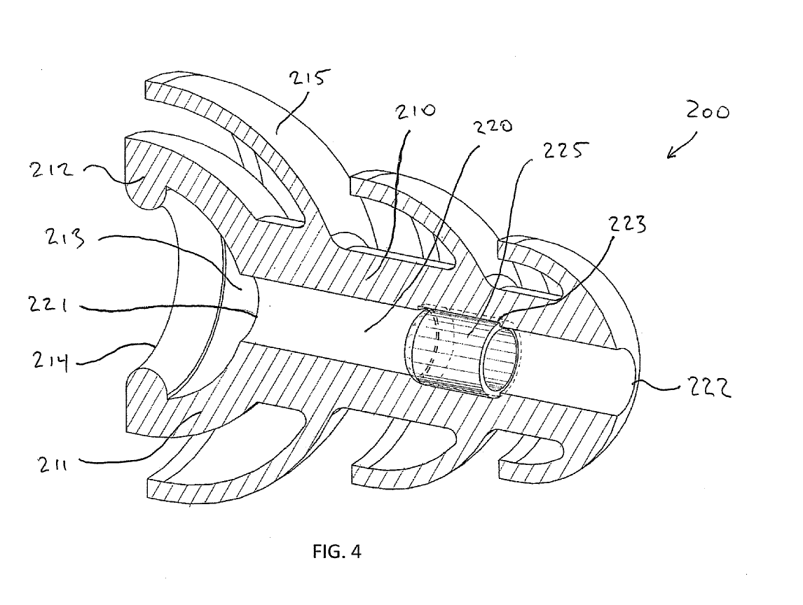

FIGS. 2A-2C and 4 depict views of an exemplary flexible eartip 200 with retention base 211 in accordance with embodiments of the present technology. FIG. 2D depicts a partial cross-sectional view of an exemplary flexible eartip 200 with retention base 211 coupled to an earphone 10 in accordance with embodiments of the present technology. The flexible eartip 200 may be operable to couple to a hearing device 10, such as an earphone or plug for providing and/or regulating sound provided to an ear canal of a wearer. Referring to FIGS. 2A-2D and 4, the eartip 200 comprises a body 210 with a sound channel 220 extending through the body 210.

The body 210 is flexible such that it may bend at curves of an ear canal of a wearer. The flexibility of the body 210 of the eartip 200 provides a comfortable fit for wearers despite different shaped ear canals. The body 210 can include, or be attached to, one or more flanges 215, a tip, compressible foam, or any suitable mechanism for providing a seal within an ear canal. The body 210 comprises a retention base 211 operable to receive and detachably secure a sound tube 15 or stem of an earphone 10 or plug. The retention base 211 includes a retention base inlet 214 and defines a retention base cavity 213 for receiving an earphone sound tube 15 or a plug stem. As an example, referring to FIGS. 2B-2D and 4, the retention base 211 receives a sound tube 15 of an earphone 10 through the retention base inlet 214 and within the retention base cavity 213 such that the sound tube 15 abuts a first end inlet 221 of a sound channel 220 of the eartip 200, as described below. The retention base 211 comprises one or more protrusions 212, barbs, hooks, snaps, or the like for mating with a sound tube 15 or stem of an earphone 10 or plug to detachably secure the eartip 200 to the earphone 10 or plug. As an example, as illustrated in FIGS. 2B-2D and 4, the retention base 211 includes a ridge 212 that mates with a groove of a sound tube 15 to detachably secure the eartip 200 to the earphone 10.

The sound channel 220 comprises a first end inlet 221 and a second end outlet 222. In various embodiments, a diameter of the sound channel 220 is substantially the same between the first end inlet 221 and the second end outlet 222. The first end inlet 221 is operable to receive sound from a sound tube 15 of an earphone 10 that is secured within the retention base cavity 213 of the eartip 200 directly adjacent to the first end inlet 221. The second end outlet 222 is operable to transmit sound from the sound channel 220 into an ear canal of a wearer. In various embodiments, the sound channel 220 can include a damper or filter 225 for modifying a frequency response of sound transmitted through the sound channel 220. The damper or filter 225 can be secured within the sound channel 220 at a sound channel recess 223 or using any suitable securement mechanism. In certain embodiments, the damper or filter 225 is secured at a predetermined distance from the second end outlet 222 to provide a desired frequency response. The sound channel 220 may be substantially straight when the eartip 200 is in a relaxed state (e.g., not inserted in an ear canal of a wearer). The sound channel 220 can be disposed within the body 210 such that the sound channel 220 is generally parallel with the body 210.

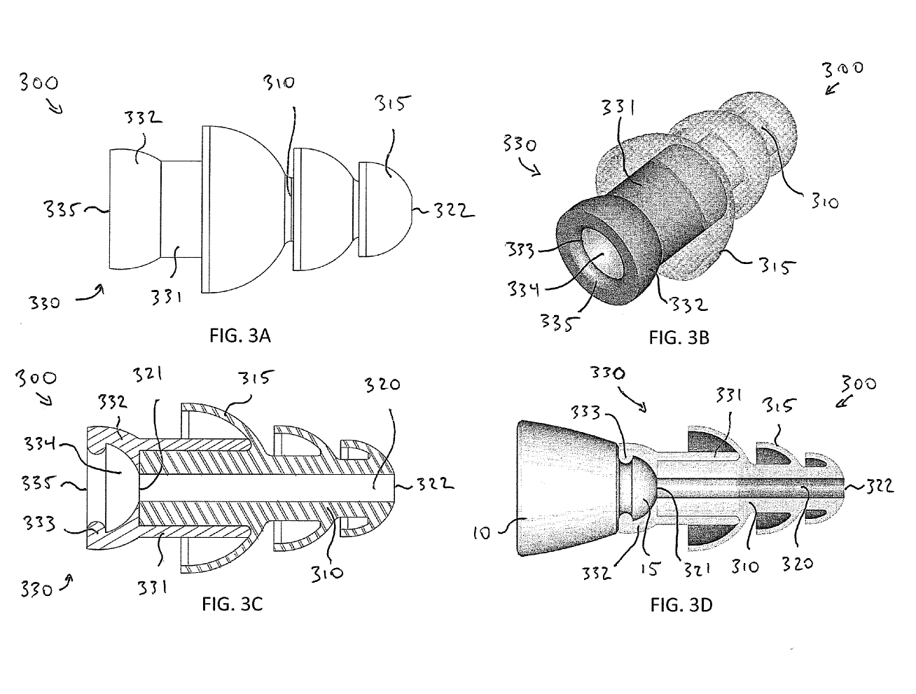

FIGS. 3A-3C depict views of an exemplary extension base 330 attached to a flexible eartip 300 in accordance with embodiments of the present technology. FIG. 3D depicts a partial cross-sectional view of an exemplary extension base 330 attached to a flexible eartip 300 and coupled to an earphone 10 in accordance with embodiments of the present technology. The flexible eartip 300 may be operable to couple to a hearing device 10, such as an earphone or plug for providing and/or regulating sound provided to an ear canal of a wearer. Referring to FIGS. 3A-3D, the eartip 300 comprises a body 310 with a sound channel 320 extending through the body 310. An extension base 330 is fixably attached to the body 310 to provide a mechanism for detachably securing the flexible eartip 300 to a sound tube 15 of an earphone 10 or a stem of a plug.

The body 310 of eartip 300 is flexible such that it may bend at curves of an ear canal of a wearer. The flexibility of the body 310 of the eartip 300 provides a comfortable fit for wearers despite different shaped ear canals. The body 310 can include, or be attached to, one or more flanges 315, a tip, compressible foam, or any suitable mechanism for providing a seal within an ear canal.

The sound channel 320 within body 310 comprises a first end inlet 321 and a second end outlet 322. In various embodiments, a diameter of the sound channel 320 is substantially the same between the first end inlet 321 and the second end outlet 322. The first end inlet 321 is operable to receive sound from a sound tube 15 of an earphone 10 that is secured within a retention base cavity 334 directly adjacent to the first end inlet 321, as described below. The second end outlet 322 is operable to transmit sound from the sound channel 320 into an ear canal of a wearer. In various embodiments, the sound channel 320 includes a damper or filter (not shown) for modifying a frequency response of sound transmitted through the sound channel 320. The sound channel 320 may be substantially straight when the eartip 300 is in a relaxed state (e.g., not inserted in an ear canal of a wearer). The sound channel 320 can be disposed within the body 310 such that the sound channel 320 is generally parallel with the body 310.

In various embodiments, an extended retention base 330 for receiving and detachably securing a sound tube 15 of an earphone 10 or a stem of a plug is fixably attached to the body 310. The extended retention base 330 includes an eartip attachment portion 331 and an earphone attachment portion 332. The eartip attachment portion 331 is fixably attached to the body 310, such as by an adhesive or any suitable attachment mechanism. The earphone attachment portion 332 is operable to receive and secure a sound tube 15 or stem of an earphone 10 or plug. The earphone attachment portion 332 includes a retention base inlet 335 and defines a retention base cavity 334 for receiving an earphone sound tube 15 or a plug stem. As an example, referring to FIGS. 3B-3D, the earphone attachment portion 332 receives a sound tube 15 of an earphone 10 through the retention base inlet 335 and within the retention base cavity 334 such that the sound tube 15 abuts a first end inlet 321 of a sound channel 320 of the eartip 300. The earphone attachment portion 332 comprises one or more protrusions 333, barbs, hooks, snaps, or the like for mating with a sound tube 15 or stem of an earphone 10 or plug to secure the eartip 300 to the earphone 10 or plug. As an example, as illustrated in FIGS. 3B-3D, the earphone attachment portion 332 includes a ridge 333 that mates with a groove of a sound tube 15 to secure the eartip 300 to the earphone 10.

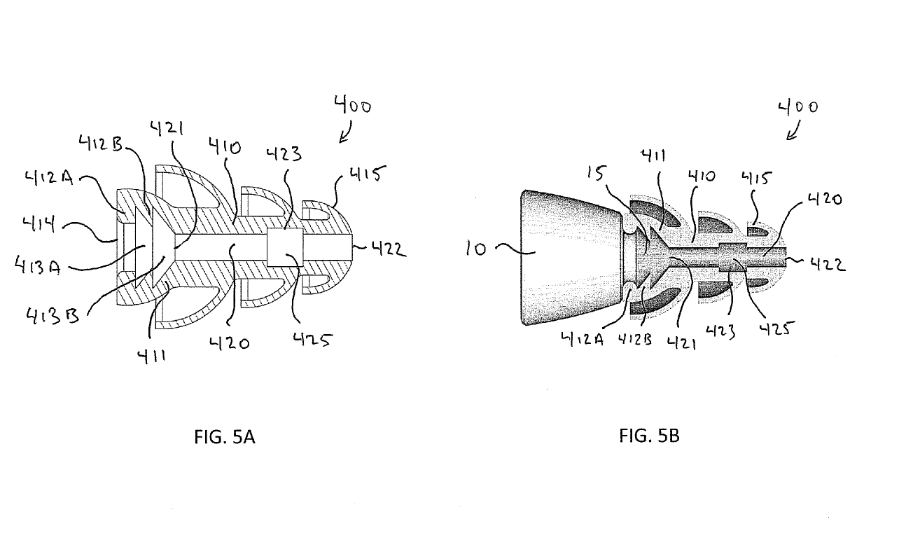

FIG. 5A depicts a cross-sectional view of an exemplary flexible eartip 400 with retention base 411 in accordance with embodiments of the present technology. FIG. 5B depicts a partial cross-sectional view of an exemplary flexible eartip 400 with retention base 411 coupled to an earphone 10 in accordance with embodiments of the present technology. The flexible eartip 400 may be operable to couple to a hearing device 10, such as an earphone or plug for providing and/or regulating sound provided to an ear canal of a wearer. Referring to FIGS. 5A-5B, the eartip 400 comprises a body 410 with a sound channel 420 extending through the body 410.

The body 410 is flexible such that it may bend at curves of an ear canal of a wearer. The flexibility of the body 410 of the eartip 400 provides a comfortable fit for wearers despite different shaped ear canals. The body 410 can include, or be attached to, one or more flanges 415, a tip, compressible foam, or any suitable mechanism for providing a seal within an ear canal.

The body 410 comprises a retention base 411 operable to receive and detachably secure a sound tube 15 or stem of an earphone 10 or plug, for example. The retention base 411 includes a retention base inlet 414 and defines one or more retention base cavities 413A, 413B for receiving an earphone sound tube 15 or a plug stem, for example. As an example, the retention base 411 receives a sound tube 15 of an earphone 10 through the retention base inlet 414 and within the retention base cavities 413A, 413B such that the sound tube 15 abuts a first end inlet 421 of a sound channel 420 of the eartip 400, as described below. The retention base 411 comprises one or more protrusions 412A, 412B, barbs, hooks, snaps, or the like for mating with a sound tube 15 or stem of an earphone 10 or plug to detachably secure the eartip 400 to the earphone 10 or plug. As an example, the retention base 411 includes ridges 412A, 412B that mate with grooves of a sound tube 15 to detachably secure the eartip 400 to the earphone 10. In various embodiments, the protrusions 412A, 412B define the shape and/or size of the retention base cavities 413A, 413B. Although FIGS. 5A-5B illustrate two protrusions 412A, 412B, more or less protrusions 412A, 412B are contemplated. For example, the retention base 411 may include one protrusion (as illustrated in FIGS. 2A-2D and 4), three protrusions, and/or more than three protrusions.

The sound channel 420 comprises a first end inlet 421 and a second end outlet 422. In various embodiments, a diameter of the sound channel 320 is substantially the same between the first end inlet 321 and the second end outlet 322. The first end inlet 421 is operable to receive sound from a sound tube 15 of an earphone 10 that is secured within the retention base cavities 413A, 413B of the eartip 400 directly adjacent to the first end inlet 421. The second end outlet 422 is operable to transmit sound from the sound channel 420 into an ear canal of a wearer. In various embodiments, the sound channel 420 includes a damper or filter 425 for modifying a frequency response of sound transmitted through the sound channel 420. The damper or filter 425 is secured within the sound channel 420 at a sound channel recess 423 or using any suitable securement mechanism. In certain embodiments, the damper or filter 425 is secured at a predetermined distance from the second end outlet 422 to provide a desired frequency response. The sound channel 420 may be substantially straight when the eartip 400 is in a relaxed state (e.g., not inserted in an ear canal of a wearer). The sound channel 420 can be disposed within the body 410 such that the sound channel 420 is generally parallel with the body 410.

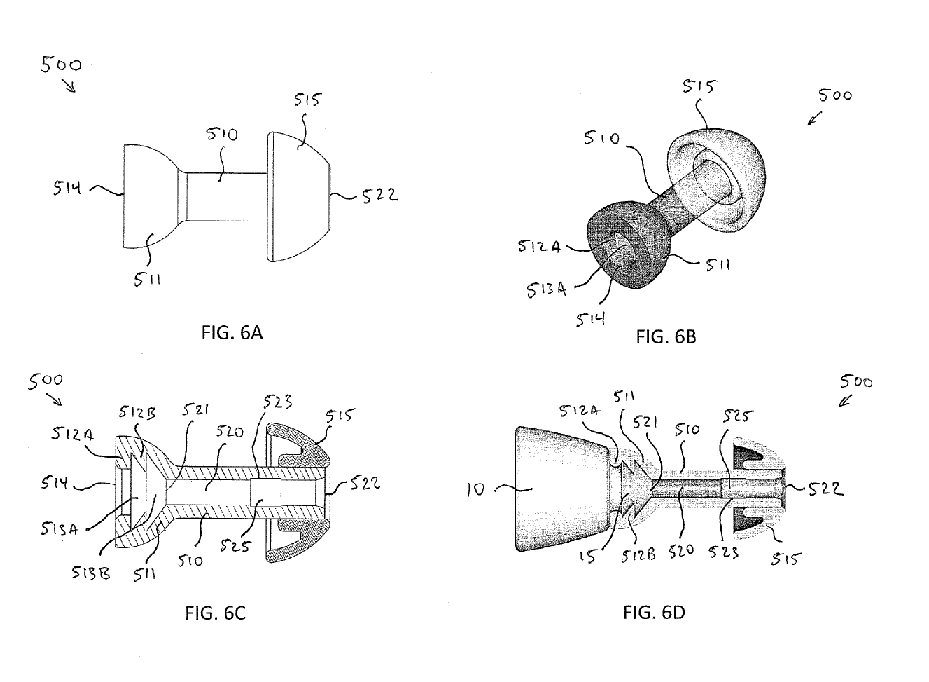

FIGS. 6A-6C depict views of an exemplary flexible eartip 500 with retention base 511 in accordance with embodiments of the present technology. FIG. 6D depicts a partial cross-sectional view of an exemplary flexible eartip 500 with retention base 511 coupled to an earphone 10 in accordance with embodiments of the present technology. The flexible eartip 500 may be operable to couple to a hearing device 10, such as an earphone or plug for providing and/or regulating sound provided to an ear canal of a wearer. Referring to FIGS. 6A-6D, the eartip 500 comprises a body 510 with a sound channel 520 extending through the body 510.

The body 510 is flexible such that it may bend at curves of an ear canal of a wearer. The flexibility of the body 510 of the eartip 500 provides a comfortable fit for wearers despite different shaped ear canals. The body 510 can include, or be attached to, a tip 515, one or more flanges, compressible foam, or any suitable mechanism for providing a seal within an ear canal. In various embodiments, the tip 515 is a soft, foam, cup tip.

The body 510 comprises a retention base 511 operable to receive and detachably secure a sound tube 15 or stem of an earphone 10 or plug, for example. The retention base 511 may include a retention base inlet 514 and can define one or more retention base cavities 513A, 513B for receiving an earphone sound tube 15 or a plug stem, for example. As an example, the retention base 511 receives a sound tube 15 of an earphone 10 through the retention base inlet 514 and within the retention base cavities 513A, 513B such that the sound tube 15 abuts a first end inlet 521 of a sound channel 520 of the eartip 500, as described below. The retention base 511 comprises one or more protrusions 512A, 512B, barbs, hooks, snaps, or the like for mating with a sound tube 15 or stem of an earphone 10 or plug to detachably secure the eartip 500 to the earphone 10 or plug. As an example, the retention base 511 includes ridges 512A, 512B that mate with grooves of a sound tube 15 to detachably secure the eartip 500 to the earphone 10. In various embodiments, the protrusions 512A, 512B define the shape and/or size of the retention base cavities 513A, 513B. Although FIGS. 6C-6D illustrate two protrusions 512A, 512B, more or less protrusions 512A, 512B are contemplated. For example, the retention base 511 may include one protrusion (as illustrated in FIGS. 2A-2D and 4), three protrusions, and/or more than three protrusions.

The sound channel 520 comprises a first end inlet 521 and a second end outlet 522. In various embodiments, a diameter of the sound channel 520 is substantially the same between the first end inlet 521 and the second end outlet 522. The first end inlet 521 is operable to receive sound from a sound tube 15 of an earphone 10 that is secured within the retention base cavities 513A, 513B of the eartip 500 directly adjacent to the first end inlet 521. The second end outlet 522 is operable to transmit sound from the sound channel 520 into an ear canal of a wearer. In various embodiments, the sound channel 520 includes a damper or filter 525 for modifying a frequency response of sound transmitted through the sound channel 520. The damper or filter 525 is secured within the sound channel 520 at a sound channel recess 523 or using any suitable securement mechanism. In certain embodiments, the damper or filter 525 is secured at a predetermined distance from the second end outlet 522 to provide a desired frequency response. The sound channel 520 may be substantially straight when the eartip 500 is in a relaxed state (e.g., not inserted in an ear canal of a wearer). The sound channel 520 can be disposed within the body 510 such that the sound channel 520 is generally parallel with the body 510.

In a representative embodiment, an eartip 200, 300, 400, 500 is provided. The eartip 200, 300, 400, 500 comprises a flexible body 210, 310, 410, 510, a sound channel 220, 320, 420, 520, and a retention base 211, 330, 411, 511. The flexible body 210, 310, 410, 510 is bendable at curves of an ear canal of a wearer. The sound channel 220, 320, 420, 520 is disposed within the flexible body 210, 310, 410, 510. The sound channel 220, 320, 420, 520 comprises a first end inlet 221, 321, 421, 521 and a second end outlet 222, 322, 422, 522. The sound channel 220, 320, 420, 520 is generally parallel with the flexible body 210, 310, 410, 510. The retention base 211, 330, 411, 511 comprises a retention base inlet 214, 335, 414, 514, one or more retention cavities 213, 334, 413A, 413B, 513A, 513B, and at least one protrusion 212, 333, 412A, 412B, 512A, 512B. The one or more retention cavities 213, 334, 413A, 413B, 513A, 513B extend from the retention base inlet 214, 335, 414, 514 to the first end inlet 221, 321, 421, 521 of the sound channel 220, 320, 420, 520. The one or more retention cavities 213, 334, 413A, 413B, 513A, 513B are configured to receive a hearing device 10. The at least one protrusion 212, 333, 412A, 412B, 512A, 512B is configured to detachably secure the hearing device 10 within the one or more retention cavities 213, 334, 413A, 413B, 513A, 513B.

In various embodiments, the eartip 200, 300, 400, 500 comprises a damper 225, 425, 525 secured within the sound channel 220, 320, 420, 520. The damper 225, 425, 525 may be secured within the sound channel 220, 320, 420, 520 at a sound channel recess 223, 423, 523. The damper 225, 425, 525 can be secured at a distance from the second end outlet 222, 322, 422, 522 of the sound channel 220, 320, 420, 520, the distance predetermined based on a desired frequency response.

In certain embodiments, the retention base 211, 411, 511 is integral to the flexible body 210, 410, 510. In various embodiments, the retention base is an extended retention base 330. The extended retention base 330 can comprise an eartip attachment portion 331 fixably attached to the flexible body 310, and an earphone attachment portion 332 comprising the retention base inlet 214, 335, 414, 514, the one or more retention cavities 213, 334, 413A, 413B, 513A, 513B, and the at least one protrusion 212, 333, 412A, 412B, 512A, 512B.

Aspects of the present invention provide that the flexible body 210, 310, 410, 510 comprises a plurality of flanges 215, 315, 415 for providing a seal within an ear canal. In certain embodiments, the flexible body 210, 310, 410, 510 comprises foam for providing a seal within an ear canal. In various embodiments, the at least one protrusion 212, 333, 412A, 412B, 512A, 512B is one ridge configured to mate with one groove of the hearing device 10. In certain embodiments, the one or more retention cavities 213, 334, 413A, 413B, 513A, 513B can be one retention cavity. In various embodiments, the at least one protrusion 212, 333, 412A, 412B, 512A, 512B is two ridges configured to mate with two grooves of the hearing device 10. In certain embodiments, the one or more retention cavities 213, 334, 413A, 413B, 513A, 513B is two retention cavities.

In various embodiments, the sound channel 220, 320, 420, 520 is substantially straight when the eartip 200, 300, 400, 500 is in a relaxed state. Aspects of the present invention provide that the sound channel 220, 320, 420, 520 comprises a diameter that is substantially constant between the first end inlet 221, 321, 421, 521 and the second end outlet 222, 322, 422, 522.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. An eartip comprising:
a flexible body, the flexible body bendable at curves of an ear canal of a wearer;
a sound channel disposed within the flexible body, the sound channel comprising a first end inlet and a second end outlet, the sound channel generally parallel with the flexible body; and
a retention base comprising:
a retention base inlet,
at least one retention cavity extending from the retention base inlet to the first end inlet of the sound channel, the at least one retention cavity configured to receive a hearing device, and
at least one protrusion configured to detachably secure the hearing device within the at least one retention cavity.

2. The eartip of claim 1, comprising a damper secured within the sound channel.

3. The eartip of claim 2, wherein the damper is secured within the sound channel at a sound channel recess.

4. The eartip of claim 2, wherein the damper is secured at a distance from the second end outlet of the sound channel, the distance predetermined based on a desired frequency response.

5. The eartip of claim 1, wherein the retention base is integral to the flexible body.

6. The eartip of claim 1, wherein the retention base is an extended retention base comprising:
an eartip attachment portion fixably attached to the flexible body, and
an earphone attachment portion comprising the retention base inlet, the at least one retention cavity, and the at least one protrusion.

7. The eartip of claim 1, wherein the flexible body comprises a plurality of flanges for providing a seal within an ear canal.

8. The eartip of claim 1, wherein the flexible body comprises foam for providing a seal within an ear canal.

9. The eartip of claim 1, wherein the at least one protrusion is one ridge configured to mate with one groove of the hearing device.

10. The eartip of claim 9, wherein the at least one retention cavity is one retention cavity.

11. The eartip of claim 1, wherein the at least one protrusion is two ridges configured to mate with two grooves of the hearing device.

12. The eartip of claim 11, wherein the at least one retention cavity is two retention cavities.

13. The eartip of claim 1, wherein the sound channel is substantially straight when the eartip is in a relaxed state.

14. The eartip of claim 1, wherein the sound channel comprises a diameter that is substantially constant between the first end inlet and the second end outlet.
